(19) United States
(12) Patent Application Publication
(10) Pub. No.: US 2024/0161963 A1
(43) Pub. Date: May 16, 2024

(54) Monolithic High Field Magnets for Plasma Target Compression

(71) Applicant: Helion Energy, Inc., Everett, WA (US)

(72) Inventors: Brian Campbell, Shoreline, WA (US); David Kirtley, Seattle, WA (US); Christopher James Pihl, Woodinville, WA (US); Akihisa Shimazu, Seattle, WA (US)

(73) Assignee: Helion Energy, Inc., Everett, WA (US)

(21) Appl. No.: 18/526,574

(22) Filed: Dec. 1, 2023

Related U.S. Application Data
(63) Continuation of application No. PCT/US22/23061, filed on Apr. 1, 2022.
(60) Provisional application No. 63/195,461, filed on Jun. 1, 2021.

(51) Int. Cl. H01F 27/26; H01F 5/04; H01F 5/06

(52) U.S. Cl. CPC H01F 27/266; H01F 5/04; H01F 5/06; H01F 27/263

(57) ABSTRACT

A single-turn coil and supporting structure for producing intense magnetic fields are described. Magnetic field and mechanical stress analyses aid in designing a magnetic coil assembly that can produce peak magnetic fields in excess of 10 Tesla in large cavities for more than 1,000 pulses.

### CROSS-REFERENCE TO RELATED APPLICATIONS

The present application is a bypass continuation of International Application No. PCT/US2022/023061, filed on Apr. 1, 2022 and entitled “Monolithic High Field Magnets for Plasma Target Compression,” which claims a priority benefit, under 35 U.S.C. § 119(e), to U.S. Application No. 63/195,461, filed on Jun. 1, 2021, and entitled “Monolithic High Field Magnets for Plasma Target Compression.” Each of these applications is incorporated herein by reference in its entirety.

### GOVERNMENT SUPPORT

This invention was made at least in part using government support under contract No. DE-AR0000563 awarded by the United States Department of Energy. The government has certain rights in the invention.

### BACKGROUND

Intense magnetic fields may be generated with a plurality of current-carrying coils that are driven with large electrical currents and high voltages. Such magnetic fields may be used to confine high-energy particles and/or to accelerate particles or objects to high velocities. In some cases, high magnetic fields may be used to confine and/or compress a plasma.

### SUMMARY

The described implementations relate to magnetic coil assemblies that can be used in a pulsed operational mode to repetitively produce magnetic fields over 10 Tesla (T). Each magnetic coil in the assembly can be formed as a single-turn coil from a solid block of material. Because of their relatively low inductance, the magnetic coils are capable of microsecond-scale rise and fall times. The magnetic coils are bolted between support plates and configured to sustain repeated production of intense magnetic fields that generate high magnetic pressures (1,000 atmospheres and higher) on the interior of the coils.

Some implementations relate to a magnetic coil assembly comprising a core formed from a solid material having a cavity that is void of the solid material and extends a length through the solid material. The magnetic coil can further include a first support structure located on a first side of the core to restrain outward motion of the core in response to magnetic pressure on the core resulting from a pulse of electrical current delivered to the core to create a magnetic field in the cavity and a second support structure located on a second side of the core to restrain outward motion of the core in response to the magnetic pressure. The magnetic coil can further include a plurality of fasteners extending through openings in the first support structure and the second support structure to clamp the core between the first support structure and the second support structure. The magnetic coil can also include structures for making electrical contact with the core to deliver the pulse of electrical current to flow around the core and around the cavity to produce the magnetic field within the cavity having a peak value in a range from 10 Tesla (T) to 50 T. A radial thickness of the core, the first support structure, the second support structure, and the plurality of fasteners can be configured to support repeated production of the magnetic field at the peak value for at least 1,000 pulses of the electrical current without replacing the core.

Some implementations relate to a method of generating a magnetic field. The method can include acts of: applying a pulse of electrical current to a magnetic coil assembly; forming the magnetic field in a core of the magnetic coil assembly in response to the applied pulse of electrical current, wherein the core is formed from a solid material having a cavity that is void of the solid material and extends a length through the solid material; restraining outward movement of a first side of the core with a first support structure; restraining outward movement of a second side of the core with a second support structure; clamping with a plurality of fasteners extending through the first support structure and the second support structure the core between the first support structure and the second support structure; and producing, at least 1,000 times without replacing the core, the magnetic field in the cavity having a peak value in a range from 10 T to 50 T with repeated applications of the pulse of electrical current.

Some implementations relate to an insulating flanged spacer comprising an insulating tube having an inner radius, an outer radius, a first end, and a second end and an insulating flange located between the first end and the second end and spaced a first distance from the first end and spaced a second distance from the second end, wherein the insulating flange extends from the tube farther than the outer radius.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 depicts an example of a magnetic field system for producing intense magnetic fields.

FIG. 2 depicts an example of a supply circuit for delivering current to a magnetic coil in the system of FIG. 1.

FIG. 3 depicts a magnetic field that may be produced by the system of FIG. 1 and also depicts a field-reversed configuration plasma that may be confined and compressed by the system.

FIG. 4 depicts, in elevation view, an example of a single-turn magnetic coil.

FIG. 5 plots simulated stress amplification for a single-turn, cylindrical magnetic coil as a function of radius ratio.

FIG. 6 plots simulated time-varying magnetic field as a function of axial distance for the magnetic field system of FIG. 1.

FIG. 7 plots simulated maximum mechanical stress in a magnetic coil assembly as a function of time.

FIG. 8 depicts, in a cut-away perspective view, an example of a single-turn magnetic coil.

FIG. 9A depicts a cross-section of a single-turn magnetic coil and supporting structure that can be used to produce intense magnetic fields.

FIG. 9B depicts an insulating flanged spacer.

### DETAILED DESCRIPTION

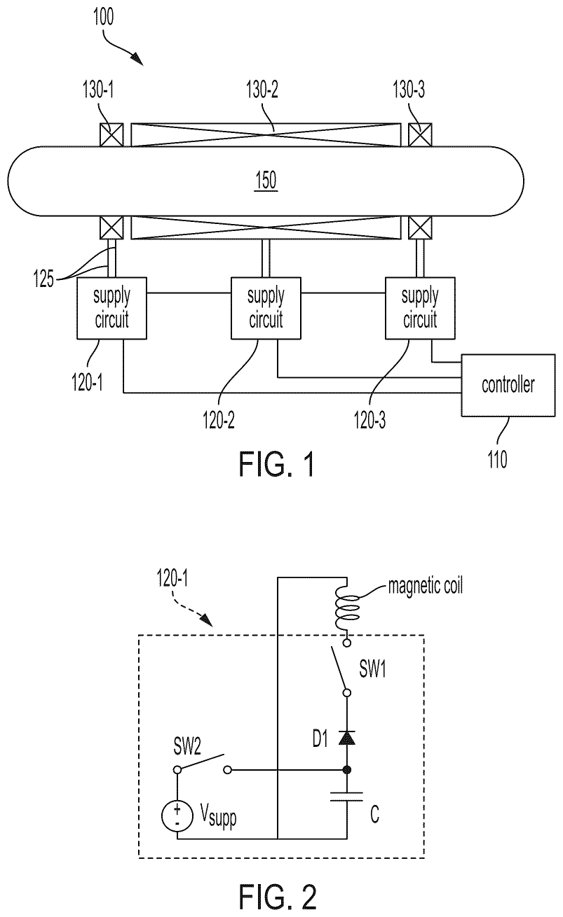

FIG. 1 depicts an example of a magnetic field system 100 that can be used to produce intense magnetic fields (e.g., peak field values between 0.01 Tesla (T) and 50 T). The system 100 includes a plurality of magnetic coils 130-1, 130-2, 130-3 that are arranged to cooperatively produce a magnetic field within a container 150 or interior space of the magnetic coils. To cooperatively produce a magnetic field, the magnetic coils 130 are spaced near enough so that the magnetic field produced by any one coil adds to the magnetic field produced by at least one other coil in the system. The magnetic coils 130 may be arranged to produce intense magnetic fields within the container 150 that is located adjacent to the magnetic coils 130. In the illustration, the container 150 and magnetic coils 130 are depicted in a cross-sectional view.

In some cases, the central coil 130-2 (or central coils if there are more than one) may be referred to as “compression coils.” The end magnetic coils 130-1, 130-3 may be referred to as “mirror coils.” In some cases, the end coils 130-1, 130-3 may be operated differently from the central compression coil(s) (e.g., supplied with higher current densities than the central coil(s)). In some cases, some of the coils 130 may be used to form or accelerate a plasma, potentially to a different set of coils that may thereafter perform compression.

For some applications (particle or object acceleration), the container 150 may comprise a tube formed from a non-magnetic material with at least one open end. In some cases, the tube may be formed in a loop with its ends joined together. For applications involving particles or plasmas, the container 150 may be implemented as part of a larger a vacuum chamber with at least one entry port to introduce particles or a plasma, for example. In such cases, the container may be made from stainless steel, a glass, a ceramic, and/or other vacuum-compatible materials that are non-magnetic. In some implementations, the inner surfaces of the magnetic coils 130 may form the container 150, at least in part. In some cases, a separate container may not be used and the coils may be placed inside a larger vacuum chamber.

The magnetic coils 130 may be formed as single-turn magnetic coils (described in further detail below). A single-turn coil may comprise a solid, conductive or superconducting core. For example, a coil may be formed from a single piece of material that is shaped to provide a path for electrical current around the container 150 or interior space of the coil. An inner diameter of the coils (enclosing a space in which an intense magnetic field is produced) can be between 1 centimeters (cm) and 300 cm or more.

Each of the magnetic coils 130 may be fed with electrical current from one or more supply circuits 120-1, 120-2, 120-3 (only one supply circuit is shown for each magnetic coil to simplify the illustration). The current may be provided over one or more supply lines 125 connected to each coil. The peak amount of current delivered to each coil can be between 1 amp (A) and 200,000,000 A or more. In some cases, the peak amperage delivered per pulse can be in a range from 500,000 A to 200,000,000 A. Each of the supply circuits 120 (explained in more detail with reference to FIG. 2 below) can include an electrical source (e.g., a voltage source), at least one energy-storage component (such as a capacitor), and at least one switch that gates a pulse of current from the at least one energy-storage component to the associated magnetic coil.

A magnetic field system can include a controller 110 that can communicate with at least one of the supply circuits 120 to control the delivery of current from at least one supply circuit to one or more of the magnetic coils 130 (e.g., by activating the supply circuit's switch(es)). The controller 110 may comprise a computer in some cases. In other cases, the controller may comprise a field-programmable gate array, a programmable logic circuit, an application-specific integrated circuit, a digital signal processor, or some combination thereof.

FIG. 2 depicts one example of a supply circuit 120-1 that may be used to deliver a pulse of current to a magnetic coil 130-1 of the magnetic field system 100 of FIG. 1. The circuit includes an energy-storage element (modeled as a capacitor C), a source (modeled as a voltage supply Vₛᵤₚₚ, switches SW1, SW2, and a diode Dl. The switches may be silicon-controlled rectifiers (SCRs), for example, though other switches may be used.

During an operational cycle, switch SW2 may be closed at the beginning of the cycle (with switch SW1 open) to provide an initial charge to the energy-storage element C, which may be one or more capacitors. Switch SW2 may then open and switch SW1 close to deliver a pulse of current to the magnetic coil 130-1 (modeled as an inductor). The pulses of large currents delivered to the magnetic coils 130 can create an intense magnetic field in the system's container 150 or interior space, which may confine and compress a plasma within the container or accelerate particles or objects.

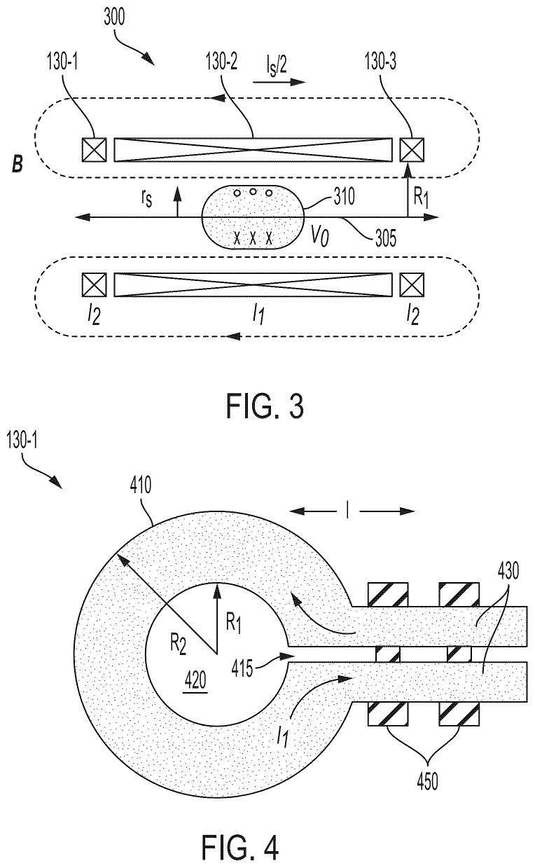

FIG. 3 depicts an example of magnetic field lines B and a contained plasma 310 for the magnetic field system 100 of FIG. 1. To simplify the drawing, the container 150, supply circuits 120, and controller 110 have been omitted and only the magnetic coil assembly 300 is shown. A cross-sectional view is shown for the magnetic coil assembly 300 and plasma 310 with it being understood that the coil assembly and plasma are three-dimensional. For example, the magnetic coils 130 and plasma 310 are symmetric with respect to a central axis 305 through the container or interior space of the coils 130. Although only three coils are shown in the illustrations, there can be 10 to 100 coils or more in a magnetic field system 100.

Magnetic field lines B are depicted with dashed lines and only one magnetic field line is shown on each side of the coil assembly 300 to indicate an approximate shape of the magnetic field within the container. The plasma is depicted as a poloidal, field-reversed configuration (FRC) plasma. A spatial extent of the plasma 310 is depicted with a solid line (which may be the location of the plasma's separatrix, for example). The separatrix is the location of the last closed magnetic field line within the plasma 310. The radius of the separatrix is rₛ (which can be between 0.2 cm and 100 cm) and a length of the separatrix is lₛ (which can be between 5 cm and 5 m).

Some applications may involve compressing such a confined plasma to increase the temperature and pressure within the plasma. In some cases, the compression may use a pulsed magnetic field that increases to more than 5 T with a rise time between 1 microsecond and 10 milliseconds from an initial state where the magnetic field may be orders of magnitude less. Further, it may be desirable to operate such a magnetic field system 100 repetitively (e.g., repeated generation of such intense magnetic fields for repeated shaping, acceleration, or compression of a plasma). Such an increase in magnetic field (and associated increase in electrical current to produce the magnetic field) with each pulse can place large stresses and strains on the magnetic coils 130 and magnetic coil assembly 300 that are used to produce the magnetic fields. Over time, such stress and strain may lead to component failure and system shut-down. Accordingly, care must be taken when designing the magnetic coils 130 and supporting structure within the coil assembly 300 so that it can sustain such repeated high stresses and strains. The inventors have recognized and appreciated that the coil deformation and motion during and after a pulse should be constrained to mitigate interference with any of the system diagnostics and adverse effects on plasma stability. The inventors have also recognized and appreciated that various pre-existing, high-field magnet technologies (e.g., multi-turn pulsed magnets, water-cooled magnets, destructive single-turn magnetics, etc.) may not be suitable for repetitively pulsing of intense magnetic fields.

To obtain repetitive pulsing of intense magnetic fields, a non-destructive, single-turn magnetic coil is described herein that has low inductance and can thus achieve a fast rise time to a peak value of the magnetic field. Although single-turn coils have been used previously to produce intense magnetic fields for a small chamber diameter of 3.2 mm (as described in Furth, H. P., Levine, M. A., and Waniek, R. W., “Production and Use of High Transient Magnetic Fields II,” Review of Scientific Instruments, Vol. 28, No. 11, 1957, pp. 949-958), single-turn coil technology has shifted to a thin-wall design where the single-turn coil is completely destroyed in a discharge when operating the system.

A great difficulty in applying existing single-turn pulsed magnet technologies for a system such as that depicted in FIG. 1, is the need to scale up the high-field magnet design to a larger inner radius R₁ that can accommodate a container 150 or interior space of sufficient size to contain a plasma 310, particles, or objects. Past non-destructive single turn pulsed coil designs typically used coil diameter of no more than 1 cm. For some magnetic field systems 100, an inner radius R₁ of 6.2 cm may be required for the magnetic coils 130. Although the peak magnetic fields may be smaller than the peak field in systems with smaller core radii (e.g., up to 50 T compared with over 100 T for the smaller radius systems), the larger diameter magnetic coils for the system of FIG. 1 are driven with longer pulse lengths of current that can cause larger destructive magnetic forces. Furthermore, spatial size and mass can become difficult or unworkable with the increased scale. For example, to sustain a same pressure with a larger R₁ value the thickness of the coil walls increases proportionately yielding a massive system that is difficult to handle, manufacture features such as the coil gap, and provide a current to that forms a desired magnetic field profile. As such, it is not possible to simply scale up the design of the smaller radius coils for the larger-diameter coils 130 of the system 100 of FIG. 1, and modifications are necessary to achieve non-destructive single-turn coils with a larger radius R₁.

Basic sizing and scales of the magnetic coils 130 for a system 100 can be obtained from a theoretical analysis of non-destructive single-turn coils for simplified and preferred geometries. FIG. 4 depicts an elevation view of an example single-turn magnetic coil 130-1 with a simplified and preferred cylindrical geometry. The coil includes a core 410 formed from one or more pieces of solid conductive material (such as aluminum, copper, stainless steel, titanium) that surrounds an interior space 420 or void where an intense magnetic field can be produced. The space 420 may have a same radius R₁ as the inner radius of the magnetic coil. A pair of feed plates can connect to the core to supply current I₁ to the core. There is a gap 415 in the core 410 to force current flow from and to the feed plates 430 around the core 410 and around the interior space 420 (e.g., from the top feed plate, around the core, and to the bottom feed plate). The gap 415 may be formed by electrical discharge machining (EDM) in some cases. There can be one or more structures (such as clear or tapped holes, tabs, etc.) for making electrical contact to the feed plates 430 (or to the core if feed plates are not present) and to deliver and remove current that circulates around the core. As described elsewhere, the current can be delivered in a sequence of pulses for repeated production of intense magnetic fields within the cavity 420. The full-width-half maximum value of the pulse duration can be in a range from 1 microsecond to 100 microseconds in some cases, from 10 microseconds to 100 milliseconds in some cases, and yet from 100 milliseconds to 1 second in some cases. Shorter pulse durations may be used in some implementations.

The feed plates 430 may be connected to the core 410 with fasteners (e.g., screwed or bolted to the core 410) or may be machined integrally with the core 410 (e.g., the core and plates may be machined from a same block of material). The feed plates can be parallel or essentially parallel to each other (e.g., within 3 degrees of parallel) or may not be parallel to each other in some cases. In some implementations, the adjacent surfaces of feed plates can include one or more curves and the gap 415 may not be uniform across the plates. There can be bolts 450 that hold the core 410 and/or feed plates 430 together, as described further below. To improve magnetic field symmetry with respect to a center of the coil assembly, a common pair of feed plates may connect to both end coils 130-1, 130-3. For example, the pair of feed plates can be Y shaped, splitting apart to allow space for a pair of feed plates to connect to a monolithic center core and coil 130-2 between the end coils. The center coil 130-1 can be fed with current from an opposite side or different direction than the feeds for the end coils.

Since the current and magnetic field pulse lengths (full-width-half-maximum) for a single-turn magnetic coil may be no more than several tens of microseconds in some applications, the penetration depth of the magnetic field into the coil's inner radial surface can be small. The magnetic loading on the coil can be approximated as a force normal to the coil's inner surface caused by the magnetic pressure, p_{B}=B²/2 μ₀. If the structural transients are neglected, by neglecting the single-turn coil gap 415 and treating the coil's core 410 as a cylinder, the stress state of the single turn coil can be approximated by a static 1-D solution to the thick-walled cylindrical pressure vessel in a plane stress state, which is given to be

$${σ}_{r} = - \frac{{( {R}_{2} / r )}^{2} - 1}{{( {R}_{2} / {R}_{1} )}^{2} - 1} {p}_{B} \qquad ( 1 )$$

$${σ}_{ϕ} = \frac{{( {R}_{2} / r )}^{2} + 1}{{( {R}_{2} / {R}_{1} )}^{2} - 1} {p}_{B}$$

where r is the radial position, R₁ and R₂ are the inner and the outer radius of the coil, respectively, and σᵣ and σ₉₉ are the radial and the azimuthal stress, respectively. In obtaining the above relations, the magnetic pressure on the outer surface of the coil is assumed to be zero.

The failure of the core's ductile metallic material can be predicted using the von Mises stress. If the von Mises stress exceeds the core material's yield strength σ_{y}, then the core material is within a plastic region. If the von Mises stress exceeds the core material's ultimate strength σᵤ, then the core will fracture and fail in that region. Preferably, the von Mises stress should not exceed the core material's yield strength so that the material remains in the elastic region of stress and strain. For the stress state of the cylindrical coil given in Eq. 1, the von Mises stress σᵤ can be expressed as follows.

$${σ}_{v} = \frac{\sqrt{1 + 3 {( {R}_{2} / r )}^{4}}}{{( {R}_{2} / {R}_{1} )}^{2} = 1} {p}_{B} \qquad ( 2 )$$

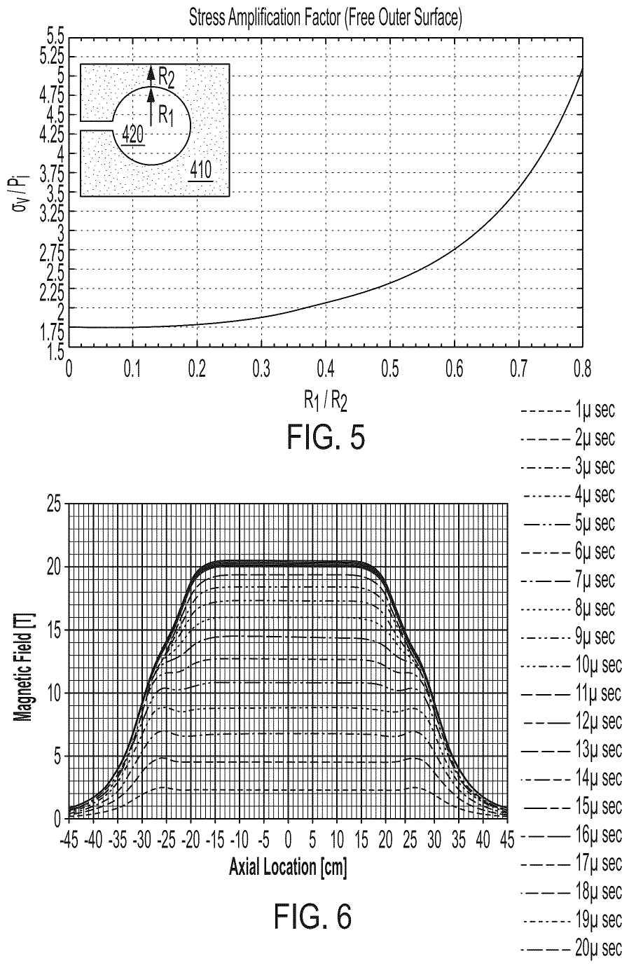

It can be seen from Eq. 2 that the maximum effective stress in the coil is obtained at the coil inner radius (r=R₁). Furthermore, the ratio σᵥ/p_{B} gives the effective stress amplification factor compared with the applied magnetic pressure P_{B}. The stress amplification factor (σᵥ/p_{B}) for reasonable ranges of the coil radius ratio R₁/R₂ is plotted in FIG. 5 for a solid core having a simple cylindrical geometry. The plot indicates that there is a rapid increase in the stress amplification for a radius ratio greater than about 0.6. The results of FIG. 5 can provide a guide for selecting sufficient coil thickness for a non-destructive coil design.

For the above analysis of the thick cylinder, the loading was assumed to be static with no transient effects. However, if the loading is pulsed and is sufficiently short, then the inertial effect of the cylinder begins to play a role in the stress distribution within the cylinder, as the cylinder does not have a sufficient reaction time to relax into the static stress concentration state at the cylinder inner radius. On the other hand, transient impulsive loading can also cause stress concentration at unexpected locations based on static linear elastic analysis as the stress wave propagates throughout the material. Accordingly, care must be taken to account for transient effects for highly transient pulse loading conditions.

If the effective pulse duration of current applied to the magnetic coil is significantly less than the natural oscillation time constant of the material, then the inertia effect of the coil can become important as the elastic deformation begins after the termination of the pulse loading. Assuming linear elastic material properties, the natural oscillation time constant of the material in the thick cylinder can be approximated to be

$${τ}_{0} = \frac{2 π}{{ω}_{0}} \approx 2 π {R}_{1} \sqrt{\frac{{ρ}_{m}}{E}} \qquad ( 3 )$$

where r₀ is natural elastic oscillation time constant of a given material, Ω₀ is natural elastic oscillation frequency, p m is mass density of the material, R₁ is the inner radius of the coil, and E is the elastic modulus of the coil material (Shneerson, G. A., Dolotenko, M. I., and Krivosheev, S. I., Strong and Superstrong Pulsed Magnetic Fields Generation, Walter de Gruyter GmbH, Berline, Germany, 2014). If the elastic deformation begins after the termination of the pulsed loading, the effective stress loading of a thick-walled cylinder becomes

$${σ}_{dyn} \approx 2 π \frac{{τ}_{eff}}{{τ}_{0}} {σ}_{st} = {ω}_{0} {τ}_{eff} {σ}_{st} \qquad ( 4 )$$

where σ_{dyn} is effective stress loading due to inertial effect, σₛₜ is static stress loading calculated using Eq. 2, and τ_{eff} is effective pulse length defined to be

$${τ}_{eff} = \frac{1}{{p}_{m}} {\int }_{0}^{∞} p ( t ) dt \qquad ( 5 )$$

where pₘ is magnitude of the peak pressure loading and p(t) is time dependent transient pressure loading profile (Shneerson, G. A., Dolotenko, M. I., and Krivosheev, S. I., Strong and Superstrong Pulsed Magnetic Fields Generation, Walter de Gruyter GmbH, Berline, Germany, 2014).

For typical crowbarred discharge of current into a magnetic coil, the magnetic induction pulse can be approximated by a sinusoidal ¼-cycle rise followed by exponential decay, which can be expressed as

$$B ( t ) = \{ \begin{matrix}{B}_{m} sin ( \frac{π}{2 {τ}_{r}} t ) & for t \leq {τ}_{r} \\ {B}_{m} exp ( - ( t - {τ}_{r} ) / {τ}_{c} ) & for t > {τ}_{r}\end{matrix} \qquad ( 6 )$$

where τᵣ is rise time and τ_{c} is e-folding decay time constant. The effective pulse length of the magnetic pulse of the form of Eq. 6 can be solved analytically to be the average of the two characteristic time scales. It should be noted that the analytical result obtained for the inertial effect in Eq. 6 is only valid when Ω₀τ_{eff}<<1 (Shneerson, G. A., Dolotenko, M. I., and Krivosheev, S. I., Strong and Superstrong Pulsed Magnetic Fields Generation, Walter de Gruyter GmbH, Berline, Germany, 2014). When Ω₀τ_{eff}>>1, then static result is valid to determine the stress distribution within the coil. In the intermediate region, both effects are present, and no simple analytical result exists.

Another effect that is of concern to the design of the high-field pulse magnet is the effect of Joule heating. Due to the high current flowing in the skin region of the coil inner radius, the thermoelastic stresses may be significant. Under the condition such that a thickness of the skin layer of the current flow is much smaller than the inner radius of the coil, the thermoelastic stresses at the inner radius of the coil can be approximated to be

$${σ}_{φ} ( {R}_{1} ) \approx {σ}_{z} ( {R}_{1} ) \approx - \frac{{α}_{0} R}{1 - ν} Δ T ( {R}_{1} ) \qquad ( 7 )$$

where α₀ is coefficient of thermal expansion and ΔT (R₁) is temperature increase at the surface of the inner radius. Assuming the coil is adiabatic and the pulse time is much shorter than the thermal conduction time constant, the temperature increase in thick coil can be represented as

$$Δ T = {\int }_{0}^{t} \frac{{( J ( r , t ) )}^{2} {ρ}_{e}}{{C}_{v}} dt \qquad ( 8 )$$

$$where J ( r , t ) \approx \frac{1}{w {δ}_{s}} B ( t ) exp ( - r / {δ}_{s} ) \qquad ( 9 )$$

$$and {δ}_{s} \approx \sqrt{\frac{{ρ}_{e}}{π f {μ}_{r} {μ}_{0}}} \qquad ( 10 )$$

where J(r, t) is current density, w is coil length, Cᵥ volumetric heat capacity, δₛ is skin depth, Iₘ is peak current, f is effective frequency, and μᵣ is relative permeability. In the above relations, Eq. 9 is an approximation as the actual skin depth is changing with respect to the time, and the use of AC skin depth given in Eq. 10 is not fully accurate (Knoepfel, H., Pulsed High Magnetic Fields, North-Holland publishing Co., Amsterdam, Netherland, 1970). However, the use of AC skin depth offers good estimation of the Joule heating effect near the coil inner radius.

Another consideration in the design of the single-turn magnetic coil is the presence of the gap 415 in the coil where the current enters and leaves the coil. If the coil gap 415 is not constrained by an external support, then the coil is allowed to open as the pulse of current is delivered, causing failure at the coil's inner surface opposite to the gap. As such, the failure criterion considered above are only accurate when the core 410 and the feed plates 430 on either side of the gap 415 are sufficiently fastened. In an implementation where bolts are used to secure the core 410 and feed plates 430 from opening, the minimum loads that the bolts must carry can be approximately derived. In the static limit, the minimum loading Fₛₜ that must be supported by the first bolts closest to the coil's gap 415 can be estimated according to the following expression

$${F}_{st} = \frac{{B}_{0}^{2} w}{4 {μ}_{0}} ( \frac{ℓ}{{η}_{f}} + 2 {R}_{0} ) \qquad ( 11 )$$

where w is the width of the coil (in a direction into the page of the drawing), η_{f} is field correction factor for feed plates 430, and [symbol] is an effective loaded length defined to be a distance from the tip of the coil feedplate slot to the midpoint between the first and second bolts closest to the core. In Eq. 11, the pair of feed plates 430 is modeled as a stripline with a uniform current density. Similarly, estimation for the bolt size in remainder of the device can be obtained using similar criteria while accounting for any changes in current density along the feed plates 430 (e.g., if the widths of the plates change).

With the above criteria in mind, a coil radius ratio R₁/R₂ may be selected for the magnetic coils 130. The radius ratio may be selected to be a value from approximately or exactly 0.3 to approximately or exactly 0.6 to provide a reasonable value for both maximum stress and size of the coil's interior space 420. For example, under a peak stress induced by magnetic pressure, the yield strength of the core material and feed plate material should exceed the peak stress at any location by a factor between 1.2 and 1.5. With a selection of R₁ and core material, the value of τ₀ can be determined using Eq. (3). Based on the expected ¼-cycle rise time described above, the effective pulse length of the magnetic field can be approximated to determine τ_{eff}.

The calculations for FIG. 5 were based on a simple cylindrical coil geometry with a uniformly thick coil wall. Some coils may have other shapes and have variations in wall thickness around the coil. In such cases the ratio R₁/R₂ is determined for the weakest portion of the solid core. The weakest portion of the solid core can be at an angular location around the core having a smallest difference between R₁ (which extends from the center of the cavity 420 to the nearest inner surface of the core) and R₂ (which extends from the center of the cavity 420 to the outer most surface of the core at the same angular location). The inset in FIG. 5 depicts how R₁/R₂ would be determined or measured for a rectangular coil where the cavity 420 is offset within the solid core. The weakest portion of the core is at an angular location around the core of 90 degrees and the gap is located at 180 degrees.

Another way to determine the ratio R₁/R₂ is to base the outer radial distance on an average value of radii at the weakest portion of the core. For example, R₂ can be expressed as an average value R_{2,a1} of all radii values extending perpendicularly from a central axis of the cavity 420 to the outer surface locations of the core along the axis (e.g., should the core have a curved outer surface along the direction of the central axis) at the angular location of the weakest portion of the core. The central axis of the cavity 420 extends into the page of the drawing, along the length of the core. In such cases, the ratio R₁/R_{2,a1} may have a value in a range from approximately or exactly 0.2 to approximately or exactly 0.6.

Yet another way to determine the ratio R₁/R₂ is to base the outer radial distance on an average value of radii to all outer surface locations around the core. For example, R₂ can be expressed as an average value R_{2,a2} of all radii values extending perpendicularly from a central axis of the cavity 420 to the outer surface locations of the core along the axis and around the core, excluding the gap. In such cases, the ratio R₁/R_{2,a2} may have a value in a range from approximately or exactly 0.4 to approximately or exactly 0.6. Of course, cores can be designed to have excess radial thickness such that any of the above ratios can be less than 0.3. However, such cores may not be desirable in terms of weight (when R₁ is greater than 20 cm), unnecessary cost and/or consumption of material (when cores are replaced), and difficulty in production (e.g., handling and forming the gap 415).

If the magnetic coils operate in the intermediate region between the static and impulsive stress loading regimes, additional numerical analyses can be used to verify the transient coil structural behavior. For such numerical analyses, an ANSYS Maxwell 3D solver can be used to model the magnetic coils and to refine and verify the coil design for desired magnetic field profile. The evolution and distribution of magnetic field can be studied to verify that the desired rise time of the compression coils, desired peak field for both compression and mirror coils, and the required initial mirror condition for FRC containment, for example, can be met with the coil geometry and currents delivered from the supply circuits 120.

For a single-turn magnetic coil described herein, the ANSYS Maxwell 3D model can be based on a simplified model of the coil geometry. For example, only one-quarter of the coil may be simulated, taking advantage of the cylindrical symmetry of the magnetic coils and neglecting the coil gap 415 to reduce the mesh size and solution time for the 3D solver. Results of such a simulation are shown in FIG. 6, which plots the time-varying magnetic field along the axis 305 of a magnetic field system like that depicted in FIG. 1. The magnetic field rises to a value of nearly 21 T within about 18 microseconds as current is delivered from the supply circuits 120 to the magnetic coils 130 of the system.

Once the time-evolving magnetic field is known throughout the magnetic field system 100, the mechanical stress and strain on components may be calculated. For example, the obtained transient magnetic loadings on the coils at the peak magnetic field can be used to compute coil structural dynamics using the ANSYS Mechanical solver. A one-way coupling can be used to couple the electromagnetic loading to the structural response, as the time scales for the structural response of the coils are much slower than that of the magnetic fields. The ANSYS Mechanical static solver may be used initially to compute the expected stress condition in the magnetic coils to verify their survivability. The static structural solver may be used initially because it can be more conservative and provide reasonable estimates for adequate external support of the coils. After converging on a coil design that shows good performance for the static condition, the transient solver can be used for further analysis of the dynamic stress and strain loadings on the magnetic coils and supporting structure. It was found that the peak stress magnitude calculated by the transient analysis substantially agrees with what is predicted by the static solver under peak loading. Accordingly, a static analysis may be sufficiently accurate for some systems.

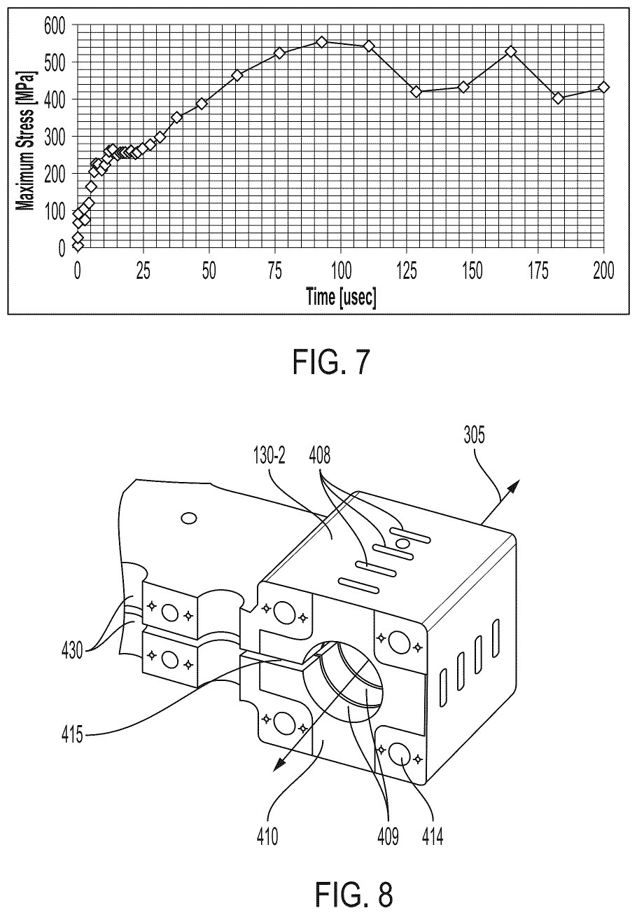

The transient analysis can provide information about the propagation of pressure waves in the magnetic coil assembly 300 and feed plates 430. It was found that the peak stress in a system can occur an appreciable time after the peak strength in the generated magnetic field, as can be seen in the plot of FIG. 7. The plot shows the maximum stress reached at any point in the coil assembly 300 as a function of time for the same magnetic field system that was analyzed in connection with FIG. 6. The maximum stress reached is about 550 megapascals (MPa) at 100 microseconds. The temporal full-width-half-maximum duration of the current pulse was less than 100 microseconds and on the order of 20 microseconds. For a system that can be operated repeatedly without replacing components of the magnetic coil assembly 300, the maximum stress reached may not exceed the yield strength of the materials from which the magnetic coil is formed. For the example system in which magnetic fields were increased up to 17 T, the maximum stress reached by the coil core and feed plates did not exceed their yield strengths at any time during or after delivery of a current pulse to the coil assembly. By keeping the peak stress below the yield limit, fatigue and failure of system components may not occur for a number of repeated firings of the magnetic coils between 100 and 5000. In some cases, the number of repeated firings, without having to change a system component (such as the coil's core 410), may be from 2 to 10, from 10 to 50, from 50 to 100, from 100 to 1,000, from 1,000 to 5,000, from 5,000 to 10,000, from 5,000 to 100,000 in some cases, and yet over 100,000 firings in some configurations. Accordingly, the system may be pulsed thousands of times or more to produce magnetic fields up to at least 17 T without replacing a system component. To the inventors' knowledge, repeated firings of a core more than 100 times to repeatedly produce magnetic field intensities over 10 T in cavities having a radius more than 1 cm has not been previously achieved. If a material's yield limit is exceeded, but not the material's ultimate yield strength, then the number of repeated firings of the magnetic coils may be between 10 and 100 before needing to replace a system component. In some cases, repeated firings of a core more than 100 times to repeatedly produce magnetic field intensities up to 50 T in cavities having a radius more than 1 cm may be achieved. In some cases, repeated firings of a core more than 100 times to repeatedly produce magnetic field intensities over 50 T in cavities having a radius more than 1 cm may be achieved.

For the example system, the peak strength of the magnetic field for the system occurs at about 20 microseconds, as indicated in FIG. 6. The lag between peak magnetic loading and peak mechanical stress may be due to an initial deformation of the inner surface of the coil as momentum is transferred from the magnetic field to the coil's core. The deformation sets up a pressure wave that then propagates throughout the system inducing stress as it travels. Further numerical stress simulations showed that even if the outer surfaces of the magnetic coils could be held fixed, deformations of the coil's inner surfaces by up to 1 mm were observed.

Based on the simulations, the inventors recognized and appreciated that depending on the amount of damping experienced by the stress wave propagating through the coil assembly, the peak transient stress (which can occur significantly after the time of peak discharge current) may be suppressed compared to a peak static stress analysis. For example, since the initial stress at the time of peak discharge current is lower than the subsequently-developed peak stress, any damping mechanisms in the system may reduce the subsequent peak stress compared to a case where the damping mechanisms are not present. The numerical simulation did not include the effects of insulating plates, described further below, which may provide some damping and reduce the peak stress.

FIG. 8 depicts further details of a portion of an example coil assembly 300 that may be implemented in the magnetic field system 100 of FIG. 1. A cut-away perspective view of the portion is illustrated and shows a single-turn coil 130-2 that can be supplied with current by integrated feed plates 430. The single-turn coil 130-2 and feed plates 430 can be formed as a monolithic structure from a same piece of material. The coil gap 415 and gap between the plates can be formed using a wire-cut electrical discharge machining (EDM) process to obtain thin and low inductive gap. In some cases, the coil 130-2 and feed plates 430 may be separate components that are assembled together.

A square-shaped coil core 410 is used because it can provide enhanced bolting capability for coils. In some cases, the coil core 410 may be triangular, rectangular, hexagonal, or elliptical in cross section, though other shapes are possible. Using a square or rectangular coil geometry rather than the common cylindrical geometry can allow at least four axial bolts to be installed to the coil assembly (through the four holes 414 illustrated in FIG. 8 at the corners of the square core 410) without reducing the effective minimum outer radius of the coil. Clamping of the coil assembly (in a direction transverse to the central axis 305) also becomes easier with a square geometry. The coil core 410 and plates may be formed from aluminum, copper, steel or another suitable metal. One example material is high-strength aluminum 7075-T6 which exhibits good machinability, low resistivity compared to steel, and superior strength compared to copper.

To be able to diagnose a FRC plasma within the coil 130-2, diagnostic ports 408 can be formed along the coil core 410 parallel to the core's axis 305. The ports 408 extend from an exterior surface of the core to an interior surface of the core 410, allowing a clear line of sight from outside the core to the core's axis 305. To prevent any stress concentration near the diagnostic port opening at the coil inner radius where the stress is highest, a circumferential cut to form a trench 409 may be made to the inner core surface. The port opening may land within a bottom surface of the trench 409 and may not touch the walls of the trench 409. Removing material at these axial locations effectively shields the core's surface around the interior port openings from the high axial magnetic fields. As a result, the magnetic pressure applied to the inner most cylindrical surface on which the diagnostic port opening is located is significantly lower than that applied at the coil inner radius, reducing the magnitude of the stress concentration that occurs near the interior diagnostic port opening. While this removal of material weakens the coil 130 for axial compression, the axial stress experienced by the coil is significantly lower than that encountered due to radial loading. Furthermore, axial stress concentration due to material removal occurs away from the coil inner radius, thus it does not amplify the peak stress that is encountered at the coil inner radius.

Due to the increased surface area with a larger coil radius, the clamping load required to withstand the destructive opening load from the magnetic field becomes a top issue in the design of the magnetic coils. At the same time, due to spatial constraints of the coil assembly, it becomes more difficult to add additional bolts away from the feed plates 430 to support the increased magnetic loading. The magnetic coil and feed plate designs may be selected to minimize the magnetic pressure and maximize the bolting capabilities.

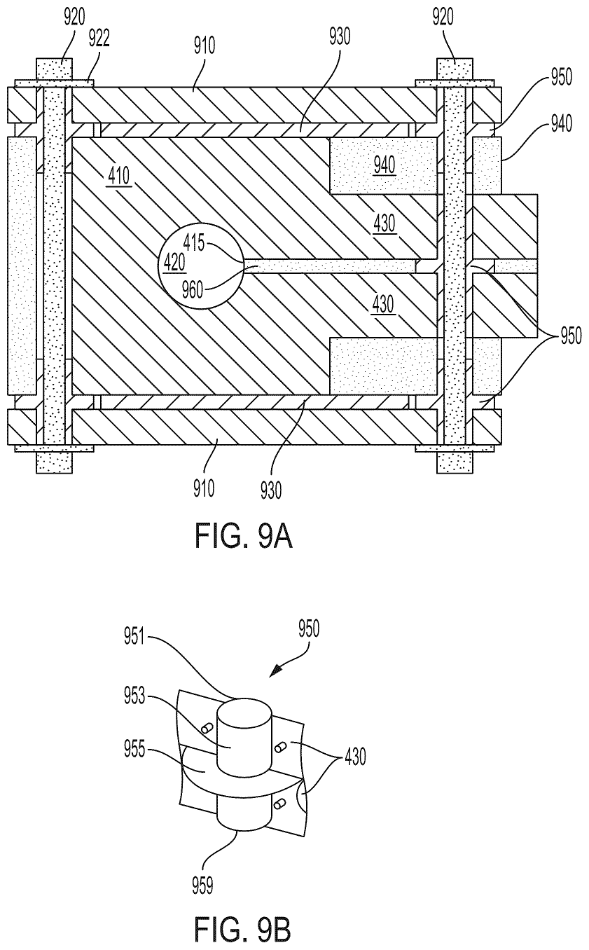

FIG. 9A depicts an example coil assembly with supporting structure in further detail. The supporting structure can be arranged to prevent the coil's core 410 and feed plates 430 from opening under high magnetic pressure. The supporting structure can include support plates 910 arranged on opposing sides of the feed plates 430 and core 410 that are parallel or essentially parallel to the coil's gap 415. Bolts 920 can be used to clamp the support plates 910 together, sandwiching the core 410 and feed plates 430 between the plates 910. Some of the bolts 920 may pass through holes in the feed plates 430. The support plates 910 and bolts 920 may be formed from high-strength material, such as steel, though other materials may be used. In some cases, the bolts may be grade 8 or metric class 12.9 bolts.

To prevent electrical shorting across the magnetic coil and/or feed plates 430, the support plates 910 and bolts 920 are insulated from the core 410 and feed plates 430. For example, an insulating sheet 930 can be positioned between each steel plate 910 and the core 410. The insulating sheet may be formed from a polymer, fiber-reinforced polymer, or ceramic. To fill larger spaces in the assembly, insulating plates 940 may be used that are formed from a fiber-reinforced polymer such as G10 fiberglass laminate. Though the drawing shows two insulating plates 940 between the support plates 910 and feed plates 430, there may be only one (e.g., if the feed plates 430 are located at a bottom or top edge of the core 410 instead of mid-way between the bottom and top edges as is the case for the illustrated example). In some implementations, an insulating sheet 960 may fill at least a portion of the gap 415 in the core and between the feed plates 430. The insulating sheet 960 may be formed from a polymer, fiber-reinforced polymer, or ceramic.

To insulate the bolts 920 from surrounding metal structure and to retain the bolts centrally in holes, flanged spacers 950 may be used. A perspective view of a flanged spacer 950 is shown in FIG. 9B. The flanged spacer 950 can include a tube 953 having a radius and a flange 955 between opposing ends 951, 959 of the spacer. For example, the flange 955 may be located within a central portion (mid third) of the tube 953 that is one-third the length of the tube measured between the tubes ends 951, 959. The flange 955 can extend from the tube 953 a distance that is greater than the radius of the tube 953. The flange 955 can be integrally formed with the spacer's tube 953 (e.g., formed in a same molding or machining process) or may be bonded or adhered to the tube 953. In some cases, there can be a flange 955 at one or both ends of the spacer 950 instead of between the ends. The flanged spacer 950 may be formed from a polymer or fiber-reinforced polymer.

High field magnets may be implemented in various configurations. Some example implementations are listed below.
(1) A magnetic coil assembly comprising a core formed from a solid material having a cavity that is void of the solid material and extends a length through the solid material; a first support structure located on a first side of the core to restrain outward motion of the core in response to magnetic pressure on the core resulting from a pulse of electrical current delivered to the core to create a magnetic field in the cavity; a second support structure located on a second side of the core to restrain outward motion of the core in response to the magnetic pressure; a plurality of fasteners extending through openings in the first support structure and the second support structure to clamp the core between the first support structure and the second support structure; and structures for making electrical contact with the core to deliver the pulse of electrical current to flow around the core and around the cavity to produce the magnetic field within the cavity having a peak value in a range from 10 Tesla (T) to 50 T, wherein a radial thickness of the core, the first support structure, the second support structure, and the plurality of fasteners are configured to support repeated production of the magnetic field at the peak value for at least 1,000 pulses of the electrical current without replacing the core.
(2) The magnetic coil assembly of configuration (1), wherein, at an angular location around the core where the weakest portion of the core is located, a ratio of a first radial distance R1 extending from a center of the cavity to an inner surface of the core surrounding the cavity to a second average radial distance R2,a1 has a value in a range from 0.2 to 0.6, wherein R2,a1 is an average value of all radii values extending perpendicularly from a central axis of the cavity 420 to outer surface locations of the core along the central axis at the angular location.
(3) The magnetic coil assembly of configuration (2), wherein the first radial distance is between 0.5 cm and 150 cm.
(4) The magnetic coil assembly of any one of configurations (1) through (3), wherein a peak stress in the core, when producing the magnetic field, does not exceed the yield strength of the solid material.
(5) The magnetic coil assembly of any one of configurations (1) through (4), wherein a full-width-half-maximum duration of the pulse of electrical current, when applied to the core, is less than 100 milliseconds.
(6) The magnetic coil assembly of any one of configurations (1) through (5), further comprising an insulating flanged spacer mounted on a fastener of the plurality of fasteners, wherein the insulating flanged spacer comprises: an insulating tube having an inner radius and an outer radius; and an insulating flange located between opposing ends of the insulating tube, wherein the insulating flange extends radially from the tube farther than the outer radius.
(7) The magnetic coil assembly of any one of configurations (1) through (6), further comprising: a first insulating material located between the first support structure and the first side of the core to electrically insulate the first support structure from the core; and a second insulating material located between the second support structure and the second side of the core to electrically insulate the first support structure from the core.
(8) The magnetic coil assembly of configuration (7), wherein the first insulating material and the second insulating material are formed from fiber-reinforced polymer.
(9) The magnetic coil assembly of any one of configurations (1) through (8), wherein the structures for making electrical contact with the core comprises: a first feed plate connected to the core to transmit current to the core; and a second feed plate spaced apart from the first feed plate by a gap and connected to the core to receive current from the core.
(10) The magnetic coil assembly of any one of configurations (7) through (9), wherein the first insulating material extends over the first feed plate and the second insulating material extends over the second feed plate to participate in clamping the first feed plate and the second feed plate between the first support plate and the second support plate.
(11) The magnetic coil assembly of configuration (9), wherein the first feed plate, the second feed plate, and the core are formed monolithically from a same piece of the solid material.
(12) The magnetic coil assembly of any one of configurations (1) through (11), wherein the solid material includes aluminum, copper, stainless steel, or a superconducting material.
(13) The magnetic coil assembly of any one of configurations (1) through (12), wherein the core has a rectangular cross section in a direction transverse to a direction of the length of the cavity.
(14) The magnetic coil assembly of any one of configurations (1) through (13), wherein the core is a first core and the plurality of fasteners is a first plurality of fasteners, and further comprising: a second plurality of fasteners securing the first core to a second core such that the cavity of the first core aligns to a cavity of the second core.
(15) The magnetic coil assembly of any one of configurations (1) through (14), further comprising: a diagnostic port void formed in the solid material and extending from the outer surface of the core to the cavity; and a trench formed along an interior surface of the magnetic coil adjacent to the cavity, wherein an interior opening of the diagnostic port void is located in the trench.
(16) The magnetic coil assembly of any one of configurations (1) through (15) in combination with a supply circuit, the supply circuit comprising: a voltage source; at least one energy-storage component; and at least one switch to gate the pulse of electrical current from the at least one energy-storage component to the structures for making electrical contact with the core.
(17) The magnetic coil assembly of configuration (16), wherein the at least one switch comprises a silicon-controlled rectifier.

High field magnets of the above configurations can include an insulating flanged spacer, some examples of which are listed below.
(18) An insulating flanged spacer comprising: an insulating tube having an inner radius, an outer radius, a first end, and a second end; and an insulating flange located between the first end and the second end and spaced a first distance from the first end and a second distance from the second end, wherein the insulating flange extends from the tube farther than the outer radius.
(19) The insulating flanged spacer of configuration (18), wherein the insulating flange is integrally formed with the insulating tube from a single piece of material.
(20) The insulating flanged spacer of configuration (18) or (19), wherein the insulating flange is formed from a fiber-reinforced polymer.

High field magnets of the above configurations (1) through (17) can be operated in various ways, some examples of which are listed below.
(21) A method of generating a magnetic field, the method comprising: applying a pulse of electrical current to a magnetic coil assembly; forming the magnetic field in a core of the magnetic coil assembly in response to the applied pulse of electrical current, wherein the core is formed from a solid material having a cavity that is void of the solid material and extends a length through the solid material; restraining outward movement of a first side of the core with a first support structure; restraining outward movement of a second side of the core with a second support structure, wherein the outward movement of the first side of the core and the outward movement of the second side of the core are caused by magnetic pressure on the core by the magnetic field; clamping with a plurality of fasteners extending through the first support structure and the second support structure the core between the first support structure and the second support structure; and producing, at least 1,000 times without replacing the core, the magnetic field in the cavity having a peak value in a range from 10 T to 50 T with repeated applications of the pulse of electrical current.
(22) The method of (21), wherein, at an angular location around the core where the weakest portion of the core is located, a ratio of a first radial distance R1 extending from a center of the cavity to an inner surface of the core surrounding the cavity to a second average radial distance R2,a1 has a value in a range from 0.2 to 0.6, wherein R2,a1 is an average value of all radii values extending perpendicularly from a central axis of the cavity 420 to outer surface locations of the core along the central axis at the angular location.
(23) The method of (21) or (22), further comprising: selecting a duration of the pulse of electrical current such that a peak stress in the solid material after applying the pulse of electrical current does not exceed the yield strength of the solid material.
(24) The method of any one of (21) through (23), wherein a full-width-half-maximum duration of the applied pulse of electrical current is less than 100 milliseconds.
(25) The method of any one of (21) through (24), further comprising operating at least one switch of a supply circuit to deliver the applied pulse of electrical current to the core from an energy-storage component.
(26) The method of any one of (21) through (25), wherein the applied pulse of electrical current has a peak value between 500 thousand amps and 200 million amps.
(27) The method of any one of (21) through (26), further comprising: transmitting the applied pulse of electrical current to the core with a first feed plate that is electrically connected to the core; and transmitting the applied pulse of electrical current from the core with a second feed plate that is electrically connected to the core and separated from the first feed plate with a gap.
(28) The method of any one of (21) through (27), further comprising: electrically insulating the core from the first support structure with a first insulating material located between the first support structure and the core; and electrically insulating the core from the second support structure with a second insulating material located between the second support structure and the core.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A magnetic coil assembly comprising:
a core formed from a solid material having a cavity that is void of the solid material and extends a length through the solid material;
a first support structure located on a first side of the core to restrain outward motion of the core in response to magnetic pressure on the core resulting from a pulse of electrical current delivered to the core to create a magnetic field in the cavity;
a second support structure located on a second side of the core to restrain outward motion of the core in response to the magnetic pressure;
a plurality of fasteners extending through openings in the first support structure and the second support structure to clamp the core between the first support structure and the second support structure; and
structures for making electrical contact with the core to deliver the pulse of electrical current to flow around the core and around the cavity to produce the magnetic field within the cavity having a peak value in a range from 10 Tesla (T) to 50 T,
wherein a radial thickness of the core, the first support structure, the second support structure, and the plurality of fasteners are configured to support repeated production of the magnetic field at the peak value for at least 1,000 pulses of the electrical current without replacing the core.

2. The magnetic coil assembly of claim 1, wherein, at an angular location around the core where the weakest portion of the core is located, a ratio of a first radial distance R₁ extending from a center of the cavity to an inner surface of the core surrounding the cavity to a second average radial distance R_{2,a1} has a value in a range from 0.2 to 0.6, wherein R_{2,a1} is an average value of all radii values extending perpendicularly from a central axis of the cavity to outer surface locations of the core along the central axis at the angular location.

3. The magnetic coil assembly of claim 2, wherein the first radial distance R₁ is between 0.5 cm and 150 cm.

4. The magnetic coil assembly of claim 1, wherein a peak stress in the core, when producing the magnetic field, does not exceed a yield strength of the solid material.

5. The magnetic coil assembly of claim 1, wherein a full-width-half-maximum duration of the pulse of electrical current, when applied to the core, is less than 100 milliseconds.

6. The magnetic coil assembly of claim 1, further comprising an insulating flanged spacer (950) mounted on a fastener of the plurality of fasteners, wherein the insulating flanged spacer comprises:
an insulating tube (953) having an inner radius and an outer radius; and
an insulating flange (955) located between opposing ends of the insulating tube, wherein the insulating flange extends radially from the insulating tube farther than the outer radius.

7. The magnetic coil assembly of claim 1, further comprising:
a first insulating material (930) located between the first support structure and the first side of the core to electrically insulate the first support structure from the core; and
a second insulating material (930) located between the second support structure and the second side of the core to electrically insulate the first support structure from the core.

8. The magnetic coil assembly of claim 7, wherein the first insulating material and the second insulating material are formed from fiber-reinforced polymer.

9. The magnetic coil assembly of claim 7, wherein the structures for making electrical contact with the core comprises:
a first feed plate (430) connected to the core to transmit current to the core; and
a second feed plate (430) spaced apart from the first feed plate by a gap (415) and connected to the core to receive current from the core.

10. The magnetic coil assembly of claim 9, wherein the first insulating material extends over the first feed plate and the second insulating material extends over the second feed plate to participate in clamping the first feed plate and the second feed plate between the first support structure and the second support structure.

11. The magnetic coil assembly of claim 9, wherein the first feed plate, the second feed plate, and the core are formed monolithically from a same piece of the solid material.

12. The magnetic coil assembly of claim 1, wherein the solid material includes aluminum, copper, stainless steel, or a superconducting material.

13. The magnetic coil assembly of claim 1, wherein the core has a rectangular cross section in a direction transverse to a direction of the length of the cavity.

14. The magnetic coil assembly of claim 1, wherein the core is a first core and the plurality of fasteners is a first plurality of fasteners, and further comprising:
a second plurality of fasteners securing the first core to a second core such that the cavity of the first core aligns to a cavity of the second core.

15. The magnetic coil assembly of claim 1, further comprising:
a diagnostic port void (408) formed in the solid material and extending from an outer surface of the core to the cavity; and
a trench (409) formed along an interior surface of the magnetic coil assembly adjacent to the cavity, wherein an interior opening of the diagnostic port void is located in the trench.

16. The magnetic coil assembly of claim 1 in combination with a supply circuit, the supply circuit comprising:
a voltage source;
at least one energy-storage component; and
at least one switch to gate the pulse of electrical current from the at least one energy-storage component to the structures for making electrical contact with the core.

17. The magnetic coil assembly of claim 16, wherein the at least one switch comprises a silicon-controlled rectifier.

18. An insulating flanged spacer comprising:
an insulating tube having an inner radius, an outer radius, a first end, and a second end; and
an insulating flange located between the first end and the second end and spaced a first distance from the first end and a second distance from the second end, wherein the insulating flange extends from the insulating tube farther than the outer radius.

19. The insulating flanged spacer of claim 18, wherein the insulating flange is integrally formed with the insulating tube from a single piece of material.

20. The insulating flanged spacer of claim 18, wherein the insulating flange is formed from a fiber-reinforced polymer.

21. A method of generating a magnetic field, the method comprising:
applying a pulse of electrical current to a magnetic coil assembly;
forming the magnetic field in a core of the magnetic coil assembly in response to the pulse of electrical current, wherein the core is formed from a solid material having a cavity that is void of the solid material and extends a length through the solid material;
restraining outward movement of a first side of the core with a first support structure;
restraining outward movement of a second side of the core with a second support structure, wherein the outward movement of the first side of the core and the outward movement of the second side of the core are caused by magnetic pressure on the core by the magnetic field;
clamping with a plurality of fasteners extending through the first support structure and the second support structure the core between the first support structure and the second support structure; and
producing, at least 1,000 times without replacing the core, the magnetic field in the cavity having a peak value in a range from 10 T to 50 T with repeated applications of the pulse of electrical current.

22. The method of claim 21, wherein, at an angular location around the core where the weakest portion of the core is located, a ratio of a first radial distance R₁ extending from a center of the cavity to an inner surface of the core surrounding the cavity to a second average radial distance R_{2,a1} has a value in a range from 0.2 to 0.6, wherein R_{2,a1} is an average value of all radii values extending perpendicularly from a central axis of the cavity to outer surface locations of the core along the central axis at the angular location.

23. The method of claim 21, further comprising:
selecting a duration of the pulse of electrical current such that a peak stress in the solid material after applying the pulse of electrical current does not exceed a yield strength of the solid material.

24. The method of claim 21, wherein a full-width-half-maximum duration of the pulse of electrical current is less than 100 milliseconds.

25. The method of claim 21, further comprising:
operating at least one switch of a supply circuit to deliver the pulse of electrical current to the core from an energy-storage component.

26. The method of claim 21, wherein the pulse of electrical current has a peak value between 500 thousand amps and 200 million amps.

27. The method of claim 21, further comprising:
transmitting the pulse of electrical current to the core with a first feed plate (430) that is electrically connected to the core; and
transmitting the pulse of electrical current from the core with a second feed plate (430) that is electrically connected to the core and separated from the first feed plate with a gap (415).

28. The method of claim 21, further comprising:
electrically insulating the core from the first support structure with a first insulating material (930) located between the first support structure and the core; and
electrically insulating the core from the second support structure with a second insulating material (930) located between the second support structure and the core.
